(19) United States
(12) Patent Application Publication
(10) Pub. No.: US 2026/0344616 A1
(43) Pub. Date: Nov. 5, 2026

(54) DROP FEEDER WITH SHUT OFF BALL SEAT HAVING SPHERICAL RING

(71) Applicant: The GSI Group, LLC, Assumption, IL (US)

(72) Inventors: Alan C. Hogan, Mt. Zion, IL (US); Brad K. Eversole, Shelbyville, IL (US)

(21) Appl. No.: 19/487,435

(22) PCT Filed: Apr. 25, 2024
(86) PCT No.: PCT/IB2024/054032

§ 371 Date: Nov. 24, 2025

Related U.S. Application Data
(60) Provisional application No. 63/469,708, filed on May 30, 2023.

(51) Int. Cl. A01K 5/02

(52) U.S. Cl. CPC A01K 5/0225; A01K 5/0275

(57) ABSTRACT

A feeding system includes a plurality of drop feeders connected to a feed tube. Each drop feeder includes a feed valve having a drop ball and a valve seat. In a lowered condition an outer surface of the drop ball contacts the valve seat to seal a bottom feed outlet hole. An actuating lead raises the drop ball away from the valve seat into a raised condition to allow feed through the feed valve. The valve seat is shaped with a spherical segment ring above an outlet ring, the outlet ring having a cross-section that is smaller than a diameter of the drop ball. The spherical segment ring has an arcuate shape that is concentric with that of a portion of the outer surface of the drop ball that mates with the spherical segment ring when the drop ball is in its lowered condition and resting against the valve seat.

### BACKGROUND OF THE INVENTION

### Field of Invention

The present disclosure is generally related to livestock feeding systems and, more particularly, to a drop feeder with reduced leakage.

### Description of Related Art

In livestock buildings such as open pen swine feeding facilities, it is customary to use drop feeders to supply a rationed amount of feed to individual animals. It is desirably for proper animal health to provide differing amounts of feed to each animal based on animal age, lactation, and/or gestation phase of the animal based on the best “feed curve” for the animal.

There is a problem with standard ring ball seats in drop feeding application being susceptible to leaking during vibration and agitation of the feeder. The drop feeder can leak feed down the tube when this happens declining performance of the feeder. The most common occurrence of the agitation for the drop feeder is from the animal that it is feeding. If the animal can hit the feeder an get feed to drop down, then the animal will continue to hit the feeder until it is empty.

### BRIEF SUMMARY

In one aspect the invention is directed to a feeding system for delivering feed to a plurality of stalls in a livestock building. The feeding system includes a feed tube that extends along a length of the feeding system. The feeding system also includes a plurality of drop feeders connected to the feed tube, where each drop feeder of the plurality of drop feeders is formed with a container body having a top interface that forms a top feed inlet hole that mates with the feed tube through which feed from the feed tube is delivered to the container body, and a bottom feed outlet hole in a lower portion of the container body that mates with a drop tube. Each drop feeder also includes a feed valve, the feed valve including a drop ball having an outer surface and a valve seat. In a lowered condition of the drop ball, the outer surface of the drop ball contacts the valve seat to seal the bottom feed outlet hole thereby allowing feed to collect in the container body. An actuating lead is configured to selectively raise the drop ball away from the valve seat into a raised condition, where feed is selectively delivered from the container body through the feed valve by moving the drop ball to the raised condition with the actuating lead such that feed that was trapped above the drop ball flows through the bottom feed outlet hole and into the drop tube. The valve seat is shaped with a spherical segment ring above an outlet ring, the outlet ring having a cross-section that is smaller than a diameter of the drop ball. The spherical segment ring has an arcuate shape that is substantially concentric with that of a portion of the outer surface of the drop ball that mates with the spherical segment ring when the drop ball is in its lowered condition and resting against the valve seat.

Other technical features may be readily apparent to one skilled in the art from the following figures, descriptions, and claims. This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. The disclosed subject matter will be further explained with reference to the attached figures, wherein like structure or system elements are referred to by like reference numerals throughout the several views.

FIG. 1 is a schematic of a feeding system having a plurality of drop feeders;

FIG. 2 is a is a front perspective view of a portion of the feeding system with an adjustment apparatus for the drop feeders;

FIG. 3 illustrates an enlarged perspective view of a drop feeder;

FIG. 4 illustrates an exploded view of a drop feeder;

FIG. 5 illustrates a cutaway view of a portion of the drop feeder body; and

FIG. 6A illustrates a sectional view of the drop feeder body.

FIG. 6B illustrates in enlarged portion of the sectional view of FIG. 6A.

### DETAILED DESCRIPTION

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all the elements that form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the singular forms following “a,” “an,” and “the” are intended to include the plural forms as well, unless the context clearly indicates otherwise. As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded. As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” “top,” “bottom,” “upper,” “lower,” “above,” “beneath,” “side,” etc., is used for clarity and convenience in understanding the disclosure and accompanying drawings, and does not connote or depend on any specific preference or order, except where the context clearly indicates otherwise.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

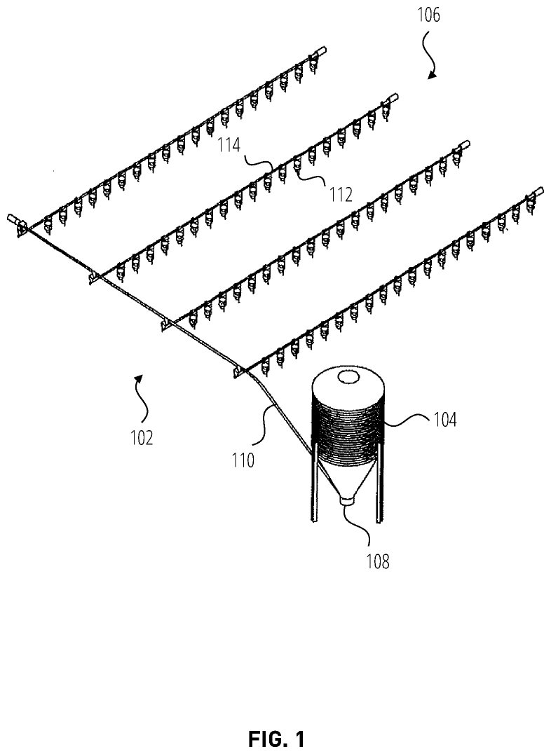

FIG. 1 illustrates a feed dispenser system 102 designed to hold and deliver feed to livestock such as swine within a livestock building (not shown). The feed dispenser system 102 includes a bulk feed tank 104 located proximate the livestock facility in which a feeding system 106 is installed. The bulk feed tank 104 has an outlet boot 108 for directing feed from within the bulk feed tank 104 to the feeding system 106 through a conveyor tube 110 in which a suitable auger or other conveyance means is driven. The bulk feed tank 104 and the conveyor tube 110 delivering feed to the feeding system 106 may be of any design and would be known to one skilled in the art and need not be discussed herein.

Within the livestock building, the feeding system 106 includes a plurality of drop feeders 112 each connected to a feed tube 114 which delivers the feed to the drop feeders 112. Typically, an auger (not shown) extends through the feed tube 114 and is driven by a suitable motor (not shown) to carry the feed from the conveyor tube 110 through the feed tube 114 to the drop feeders 112. As can be appreciated, the drop feeders 112 will fill with feed in a consecutive manner. When the final drop feeder 112 in the feeding system 106 fills with feed, a suitable sensor will sense this condition and cause a controller to deactivate the motor and stop the delivery of feed through the feeding system 106 as would be understood by one skilled in the art.

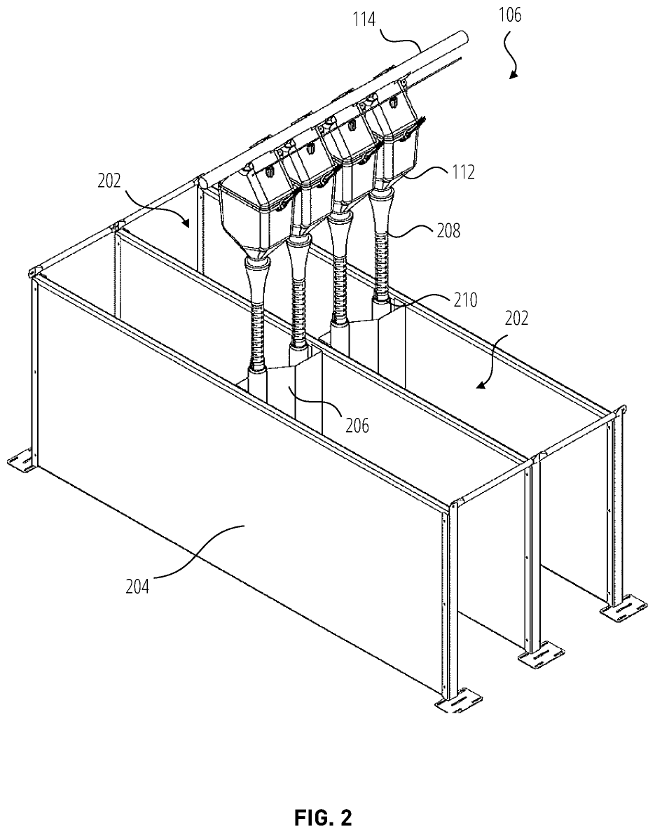

Turning now to FIG. 2 the livestock building contains a plurality of feeding stalls 202 with the feed tube 114 extending above the stalls 202 suspended from the ceiling of the livestock building. Each feeding stall 202 is each configured to receive an animal to be feed and is formed by side barriers 204 and a head barrier 206. Each drop feeder 112 is associated with one of the feeding stalls 202. Desirably, an adjustable drop tube 208 extends downwardly from the drop feeder 112 to a built-in drop tube 210 in the head barrier 206 to deliver feed to the animal in the feeding stall 202.

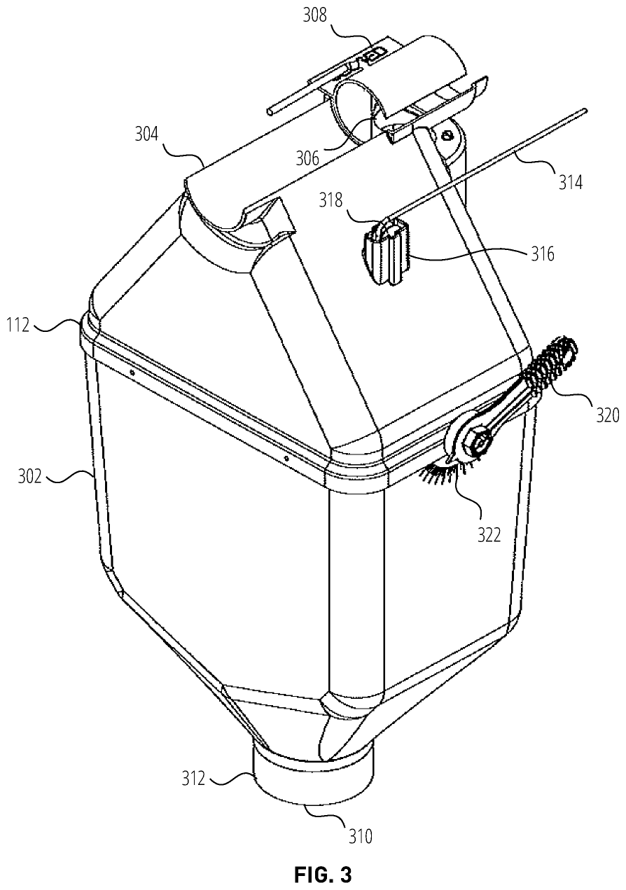

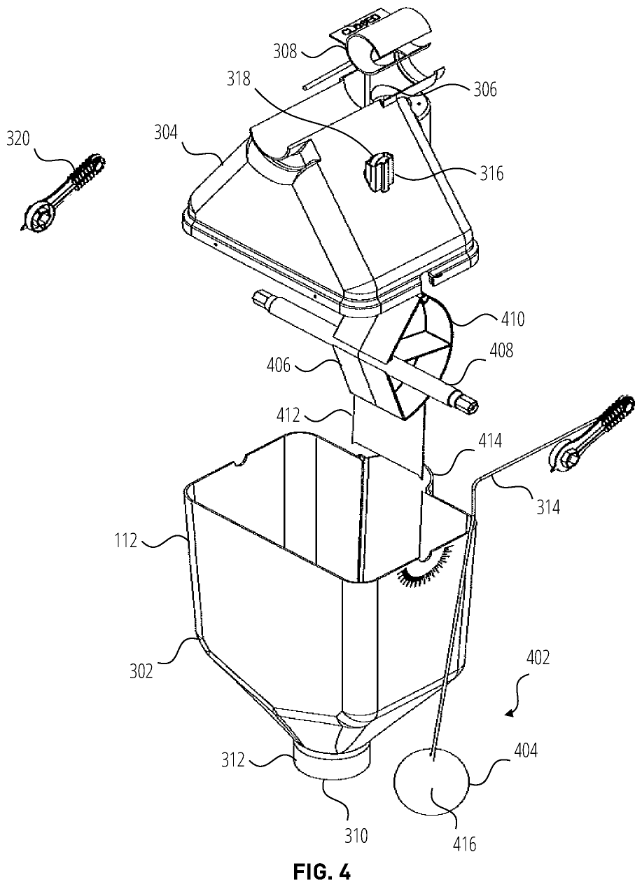

Turning also now to FIGS. 3 and 4, the drop feeder 112 is formed with a container body 302 having a top interface 304 that mates with the feed tube 114 such that a top feed inlet hole 306 in the top interface 304 delivers feed to the container body 302. Desirably, the drop feeder 112 has a shut off slide 308 that can be positioned to close off the top feed inlet hole 306 so that feed is unable to enter the drop feeder 112 from the feed tube 114. A bottom feed outlet hole 310 in a lower portion of the container body 302 mates with the adjustable drop tube 208. The drop feeder 112 has gravity drop feed valve 402 formed with a drop ball 404 that mates with a valve seat 312 in the container body 302 to seal the bottom feed outlet hole 310 thereby allowing feed to collect in the container body 302. The feed is selectively delivered from the container body 302 and down the drop tube 208 through the feed valve 402 by vertically raising the drop ball 404 away from the valve seat 312 with an actuating lead 314. In the illustrated embodiment, the actuating lead 314 connects at its proximal end to the drop ball 404 and extends through a ball actuator port 316 and around drop ball pulley 318 in the top interface 304 so that a distal end of the actuating lead 314 may be positioned remotely from the drop feeder 112 as is known in the art such as in the Ultra-Drop™M Feeder available from Automated Production Systems.

Desirably, the drop feeder 112 contains a feed level control mechanism 406 that allows a user to selectively determine the amount of feed that will collect in the container body 302 based on animal age, lactation and/or gestation phase of the animal. In one embodiment, the feed level control mechanism 406 can be manipulated to select an amount of feed between 2 lbs. (0.9 kg) and 12 lbs. (5.5 kg), however the drop feeder 112 may be designed to hold other amounts of feed. The drop feeder 112 has an adjustment lever 320 that is used to manipulate the feed level control mechanism 406. In one embodiment, the adjustment lever 320 is mounted on a shaft 408 such that pivoting movement of the adjustment lever 320 pivots the shaft 408 to selectively manipulate the feed level control mechanism 406. In one embodiment of the feed level control mechanism 406, the adjustment lever 320 and shaft 408 are rigidly attached to a drum 410 and when the adjustment lever 320 is rotated clockwise or counterclockwise, the drum 410 rotates with it. As the drum 410 rotates, it rolls up or rolls out an adjustment slide 412. The adjustment slide 412 moves vertically in a track to create a moveable wall in a feed chute 414 in the container body 302. When the feed conveyer in the feed tube 114 runs, it conveys feed to the top feed inlet hole 306 in the top interface 304. The feed drops through this top feed inlet hole 306, flows down through the feed chute 414, and fills up the bottom of the container body 302 at the “angle of repose” of the feed, beginning at the bottom of the adjustment slide 412. Desirably, an outer surface of the container body 302 adjacent the adjustment lever 320 has feed level indicia 322 so that an operator may know how much feed will be collected in the drop feeder 112 based on the selected position of the adjustment lever 320.

When the drop ball 404 at the bottom of the drop feeder 112 is raised up by moving the actuating lead 314 to a valve open position, the feed that was trapped above the drop ball 404 flows out the bottom feed outlet hole 310 of the drop feeder 112 and into the drop tube 208. When the feed valve 402 is returned to its closed condition by moving the actuating lead 314 to a valve closed position, the drop ball 404 lowers until an outer surface 416 of the drop ball 404 rests against the valve seat 312 to seal the bottom feed outlet hole 310, allowing the drop feeder 112 to again be filled with feed. The weight of the drop ball 404 plus the force of any feed pressing down on the drop ball 404 holds the feed valve 402 in the closed position.

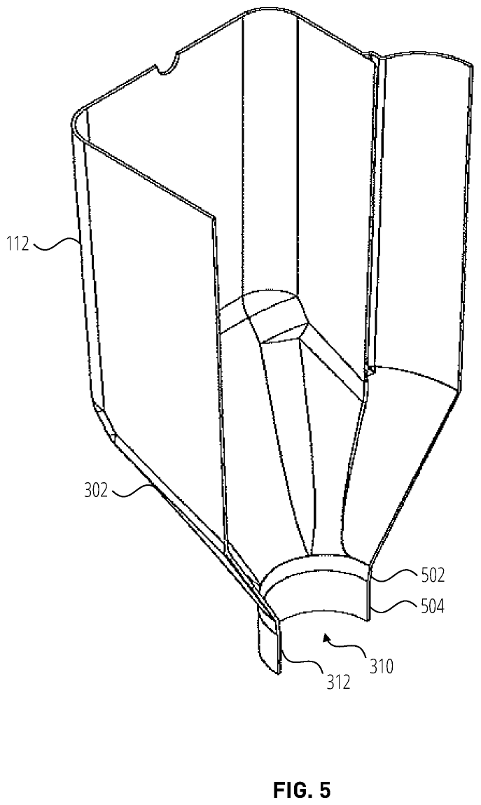

Turning also now to FIG. 5, and 6A, B, the invention is directed to a geometric shape of the valve seat 312 in the feed valve 402. The valve seat 312 is formed with a spherical segment ring 502 above an outlet ring 504 that forms the bottom feed outlet hole 310.

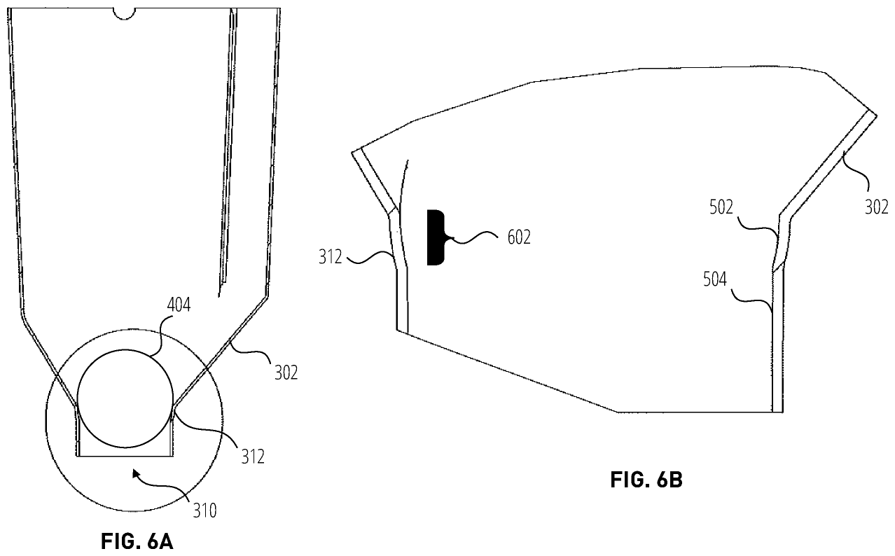

Desirably, the drop ball 404 is a sphere with a diameter of between about 3.0 inches (7.6 cm) and 5.0 inches (12.7 cm). The outlet ring 504 has a substantially circular cross-section with a diameter that that is smaller than the diameter of the drop ball 404. As perhaps best seen in the enlarged view of FIG. 6B, which has the drop ball 404 removed for clarity, the spherical segment ring 502 has a arcuate shape that is substantially concentric with that of the portion of the outer surface 416 of the drop ball 404 that mates with the spherical segment ring 502 when the drop ball 404 is in its lower-most position and resting against the valve seat 312. The spherical segment ring 502 has a vertical dimension 602 that is about 5% to about 20% of the diameter of the drop ball 404. Stated another way, the spherical segment ring 502 may be sized so that it corresponds to between about 15-degree arc to about a 20-degree arc, and in one embodiment an 18-degree arc of the surface 416 of the drop ball 404, which corresponds to about 5% of the surface 416 of the drop ball 404.

Shaping a portion of the valve seat 312 to have the spherical segment ring 502 increases the surface area of the interface between the drop ball 404 and the valve seat 312 thereby reducing leakage of feed past the feed valve 402 due to manufacturing tolerances in the valve seat 312 and drop ball 404. Additionally, having the drop ball 404 sit down in the spherical segment ring 502 reduces leakage due to possible bouncing of the drop ball 404 off the valve seat 312 as may be caused by external vibration or impact forces such as would be produced by a pig knocking any portion of the drop tube 208 or drop feeder 112. The dimensions of the spherical segment ring 502 is selected so as to provide the desired increase in mating surface area with the drop ball 404 but not have a significant angle from the vertical so as to not provide a significant ledge on which feed could build-up and hamper reseating of the drop ball 404. Desirably, the container body 302 with the valve seat 312 is produced by a blow molding manufacturing process. However, other manufacturing process may be used.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

1. A feeding system for delivering feed to a plurality of stalls in a livestock building, the feeding system comprising:
a feed tube that extends along a length of the feeding system;
a plurality of drop feeders connected to the feed tube, wherein each drop feeder of the plurality of drop feeders is formed with a container body having a top interface that forms a top feed inlet hole that mates with the feed tube through which feed from the feed tube is delivered to the container body, and a bottom feed outlet hole in a lower portion of the container body that mates with a drop tube, wherein each drop feeder also includes a feed valve, the feed valve comprising:
a drop ball having an outer surface;
a valve seat, wherein in a lowered condition of the drop ball, the outer surface of the drop ball contacts the valve seat to seal the bottom feed outlet hole thereby allowing feed to collect in the container body; and
an actuating lead configured to selectively raise the drop ball away from the valve seat into a raised condition, wherein feed is selectively delivered from the container body through the feed valve by moving the drop ball to the raised condition with the actuating lead such that feed that was trapped above the drop ball flows through the bottom feed outlet hole and into the drop tube;
wherein the valve seat is shaped with a spherical segment ring above an outlet ring, the outlet ring having a cross-section that is smaller than a diameter of the drop ball, wherein the spherical segment ring has a arcuate shape that is substantially concentric with that of a portion of the outer surface of the drop ball that mates with the spherical segment ring when the drop ball is in its lowered condition and resting against the valve seat.

2. The feeding system of claim 1, wherein a proximal end of the actuating lead connects to the drop ball.

3. The feeding system of claim 1, wherein the drop ball is a sphere with a diameter of between 3.0 inches (7.6 cm) and 5.0 inches (12.7 cm).

4. The feeding system of claim 3, wherein the spherical segment ring has a vertical dimension 602 that is between 5% to 20% of the diameter of the drop ball.

5. The feeding system of claim 1, wherein the valve seat is an integral part of the container body.

6. The feeding system of claim 1, wherein the outlet ring has a circular cross-section.

7. The feeding system of claim 1, wherein a final drop feeder of the feeding system includes a sensor configured to sense when the final drop feeder is filled with the feed.

8. The feeding system of claim 1, wherein an adjustable drop tube extends downwardly from the bottom feed outlet hole of each of the drop feeders.

9. The feeding system of claim 8, wherein each adjustable drop tube extends to a built-in drop tube in a head barrier of a respective stall of the plurality of stalls.

10. The feeding system of claim 1, further comprising a shut off slide configured to stop a flow of feed from feed tube to the top feed inlet hole.

11. The feeding system of claim 1, wherein the actuating lead extends through a ball actuator port and around a dop ball pulley in the top interface.

12. The feeding system of claim 1, further comprising a feed level control mechanism associated with each drop feeder, the feed level control mechanism configured to adjust an amount of feed provided to the drop feeder.

13. The feeding system of claim 12, wherein the feed level control mechanism comprises an adjustment level coupled to a shaft and configured to rotate a drum about an adjustment slide of a feed chute of the drop feeder.

14. The feeding system of 12, wherein each drop feeder comprises an adjustment slide configured to move vertically in a track to create a moveable wall in a feed chute of the drop feeder.

15. The feeding system of claim 12, wherein each drop feeder includes a feed level indication on an outside of the drop feeder.

16. The feeding system of claim 1, wherein the drop ball has an arc between about 15 degrees and about 20 degrees.

17. The feeding system of claim 16, wherein the art of the drop ball is about 18 degrees.

18. The feeding system of claim 1, wherein the spherical segment ring mates with about 5 percent of the outer surface of the drop ball.
